(19) United States
(12) Patent Application Publication
(10) Pub. No.: US 2006/0190812 A1
(43) Pub. Date: Aug. 24, 2006

(54) Imaging systems including hyperlink associations

(75) Inventors: Thomas William Ellenby, San Francisco, CA (US); Peter Malcolm Ellenby, San Francisco, CA (US); John Ellenby, San Francisco, CA (US)

Correspondence Address: Joseph Page, 601 Minnesota Street #212, San Francisco, CA, 94107, US

(73) Assignee: GeoVector Corporation

(21) Appl. No.: 11/062,717

(22) Filed: Feb. 22, 2005

(51) Int. Cl. G06F 15/00

(52) U.S. Cl. 715/512

(57) ABSTRACT

Computer pointing systems include schemes for producing image map type hyperlinks which are associated and stored integrally with image data from which they are derived. An object being addressed by a pointing system of is implicitly identified by way of its location and position relative to the pointing system. A geometric definition which corresponds to space substantially occupied by the addressed object is rotated appropriately such that it perspective matches that of the imaging station. When an image is captured, the image data (pixel data) is recorded and associated with image map objects which may include network addresses such as a URL. On reply, these images automatically present network hyperlinks to a user whereby the user can click on an image field and cause a browser application to be directed to a network resource.

### BACKGROUND OF THE INVENTIONS

1. Field

The following inventions disclosure is generally concerned with pointing systems used to address objects and specifically concerned with such pointing systems having an imaging function which includes providing ‘hyperlink’ type devices in combination with images.

2. Prior Art

A relatively new device provides powerful connectivity to remote information sources. Known as a ‘hyperlink’, an object such as a textual word or phrase has an underlying (sometimes hidden) network address associated therewith. Triggering the link (sometimes arranged as a “point-and-click” action), results in redirection of the medium to present the information recalled from the remote source. Of course, all users of the Internet are quite familiar with this device and it is quite well known.

While textual hyperlinks are most common, it is not necessary that a hyperlink be associated with a block of text. Indeed, hyperlink have been arranged to cooperate in conjunction with a graphical body. A ‘push button’ type object may be part of a presentation on a graphical web page. A user triggers the push button by addressing it with a ‘mouse’ pointing periphery and ‘clicking’ on the push button. The computer responds by redirecting the browser display to a new web resource which is defined by the link address which may look like this: “http://www.geovector.com/appdemos/”.

Hyperlinks are not restricted to “push button” type graphical objects. Hyperlinks are used in conjunction with “drop down” menus, “thumbnail” objects, “toolbar” objects, among others. Of particular interest, very special hyperlinks are constructed in conjunction with an “image map” object. An image map can include a digital or ‘pixelated’ image with one or more image areas which correspond to a particular subject. The image map suggests that each pixel may be a member of particular group of pixels. These groups of pixels map to certain portions of the overall image. For example, FIG. 1 presents an image of Washington D.C. which includes the Capitol building, the Washington Monument, and the Lincoln Monument. The same image 21 appears as FIG. 2 where outlines of important groups are provided as overlay. The image pixels which make up the Lincoln Monument all fall into a common area 22 suggested by the solid black outline which appears to surround the building. Similarly, the image also represents the Washington Monument as a group of pixels each falling within a common outline 23. The Capitol building similarly occupies an area in the image represented by a group of pixels 24.

The image may be presented in a web page presentation played in a browser computer application. As such, the browser enables special functionality relating to interaction with various parts of the image by way of an image map. In example, a hyperlink can be arranged whereby when addressed and triggered (point-and-click), the browser can be redirected to web resource which relates particularly to the group of pixels; for example a detailed web site relating specifically to the Lincoln Memorial. Thus the portion of the image depicted as an area enclosed by outline 22 can be associated with the web address: http://www.nps.gov/linc/. When viewing the image map presented as FIG. 2, a user having an increased interest in the Lincoln Memorial may “point-and-click” on the appropriate area to get redirected to the official web site for the Lincoln Memorial.

The image map is a computer ‘object’ and it is created by a web designer who views the image and selects and defines mathematically an area of which to associate with a particular web address. Creating these images maps is highly specialized work and takes great skill and effort. The procedure is manual, time consuming, and tedious. Accordingly, there is great need for a technique and system to automatically create such devices with little or no effort.

Advanced computer pointing systems for addressing objects have been presented in several forms. Of particular interest for this disclosure are the pointing systems for addressing objects having a well defined spatial definition—one that is stable in time or otherwise of a predictable nature. For example, a building occupies a certain space and tomorrow it is very likely to occupy the identical space.

Of considerable interest are the present inventors previous disclosures presented in U.S. Pat. Nos. 6,522,292; 6,414,696; 6,396,475; 6,173,239; and 6,037,936. Each of these is directed to pointing systems which address objects in the real world. In some cases, a computer response may be initiated whereby the particular response relates to the object being addressed.

Inventions presented in U.S. Pat. No. 6,522,292 include those which rely upon positioning systems to detect the location of the system and to permit a manual input for direction references. Together this information forms a basis upon which pointing functionality may be used to control a computer in an environment which is known to the computer.

Teachings presented in U.S. Pat. No. 6,414,696, relates to non-imaging pointing systems which are responsive to a user's surrounding by way of position and attitude determinations. Information relating to objects in the environment are recalled and presented at a display interface.

A mapping system which includes highly responsive “toolbar” type user interfaces is presented in U.S. Pat. No. 6,396,475. These toolbars respond to position and attitude measurement to implicitly determine what subject matter is of interest to a user. The toolbar features are dynamic and change with changing address conditions.

Inventor Thomas Ellenby presents in U.S. Pat. No. 6,173,239 a general pointing system for addressing objects to trigger computer response; these systems are based upon pointing and attitude determinations and specialized data searches which result in computer response being taken up when objects are addressed via user pointing actions.

U.S. Patent No. 6,037,936 by inventors Ellenby, J. et al, relates to an imaging system which captures images and displays those images alongside graphical objects such as menu items, labels, controls, et cetera. These objects may be considered graphical user interface GUI objects and they are provided with information known to relate to objects detected within the image being presented simultaneous with the GUIs.

U.S. application Ser. No. 09/769,012 sets forth in considerable detail best versions of pointing systems which recall information about objects being addressed by the system. Principles presented in this document are important to the concepts further taught herein.

Each of these pointing systems provides user means of interaction with a 3-space surrounding environment by way of position and direction information which permits the computer to distinguish objects from others nearby. The computer provides information relating to the objects as they are addressed. These disclosures and each of them is hereby incorporated into this disclosure by reference.

While systems and inventions of the art are designed to achieve particular goals and objectives, some of those being no less than remarkable, these inventions have limitations which prevent their use in new ways now possible. Inventions of the art are not used and cannot be used to realize the advantages and objectives of the inventions taught herefollowing.

### SUMMARY OF THE INVENTIONS

Comes now, Thomas, Peter, and John Ellenbyto teach new inventions of pointing image systems which include dynamic information linking including devices for and methods of connecting information stored on the Internet with image objects having a well defined spatial definition associated therewith It is a primary function of these inventions to couple pointing image system functionality with network addresses and related information connected by network addresses.

Pointing imaging systems of these inventions are used to make advanced high function digital image files. Image files produced via these systems support storage of information related to the scene being imaged. Further, very special automated image mapping function is provided. Such image mapping functions permit these images to be used at playback with point-and-click actions to link the images to particular Internet addresses. Association between objects in scenes and web address is completely automated; as is the division of image space into appropriate image maps.

Imaging systems arranged to make images and simultaneously record physical parameters relating to the image scene and the imaging device are presented. These imaging systems, sometimes herein called ‘pointing image systems’, may be used to record data about the image scene and imager at the same time an image is formed. An imager of these systems first forms an image. At the time the image is formed, the physical state of the imager, particularly with regard to its position and pointing nature, among others, is determined. These data relating to position and pointing are used in a database search to retrieve information previously stored. The database search produces information relating to the scene or objects in the scene. This information is ‘attached’ to the pixel image data and associated with the image or particular parts of the image. Such associations may be made in a special image data file with a format to support such associations.

In one version, a mobile phone including camera, location measuring capacity and compass subsystems. While forming an image of the Golden Gate bridge, the phone-imager subsystems determine that the phone is pointing North and slightly West and further than the location of the phone- imager is on the San Francisco side of the channel slightly East of the bridge landing. With this position and direction information, the system searches a database to determine that Brown's Bay Campsite is in or part of the image. As such, a specia 1 image file is created whereby pixel image data is stored along with additional information such as: the time the image was made; the city from which it was made; a list of objects in the image; among many other image related information elements.

Thus, imaging systems of these inventions include imaging systems having position and attitude determining means, a database of pre-stored information, programming to effect storage of images along with associated information.

### OBJECTIVES OF THESE INVENTIONS

It is a primary object of these inventions to provide advanced imaging systems.

It is an object of these inventions to provide imaging systems which store images along with associated image information.

It is a further object to provide imaging systems which store images and associated image information which depends upon the address nature of the imaging system.

It is an object of these inventions to provide imaging systems to record images and associated image information recalled from a database of prerecorded information.

A better understanding can be had with reference to detailed description of preferred embodiments and with reference to appended drawings. Embodiments presented are particular ways to realize these inventions and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 is an image of Washington DC comprising at least three objects of interest;

FIG. 2 is the same image having lined boarders about three objects in the image which are know to a database;

FIG. 3 is an image having been augmented with image labels identifying objects in the image;

FIG. 4 presents image regions associated with objects known to be in the image, those regions being in proper perspective and well aligned with the objects;

FIG. 5 describes three important information elements from which an image data file of these inventions may be comprised;

FIG. 6 expresses further in block diagram the elements from which an image file is comprised;

FIG. 7 is an image of the Golden Gate Bridge presented to support another example;

FIG. 8 illustrates image regions of objects recognized in view of a database search based upon position and attitude determinations;

FIG. 9 shows the non-pixel image information with proper association between image map regions;

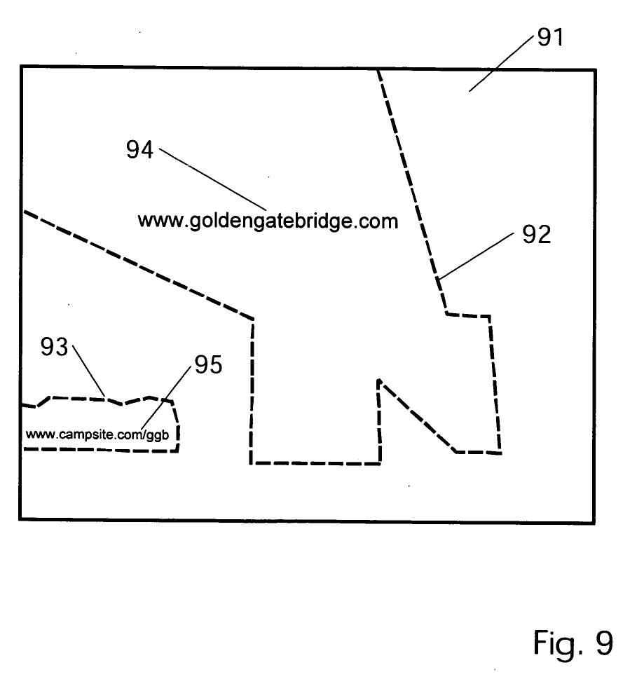

FIG. 10 is a device block diagram;

FIG. 11 is an alternative device block diagram;

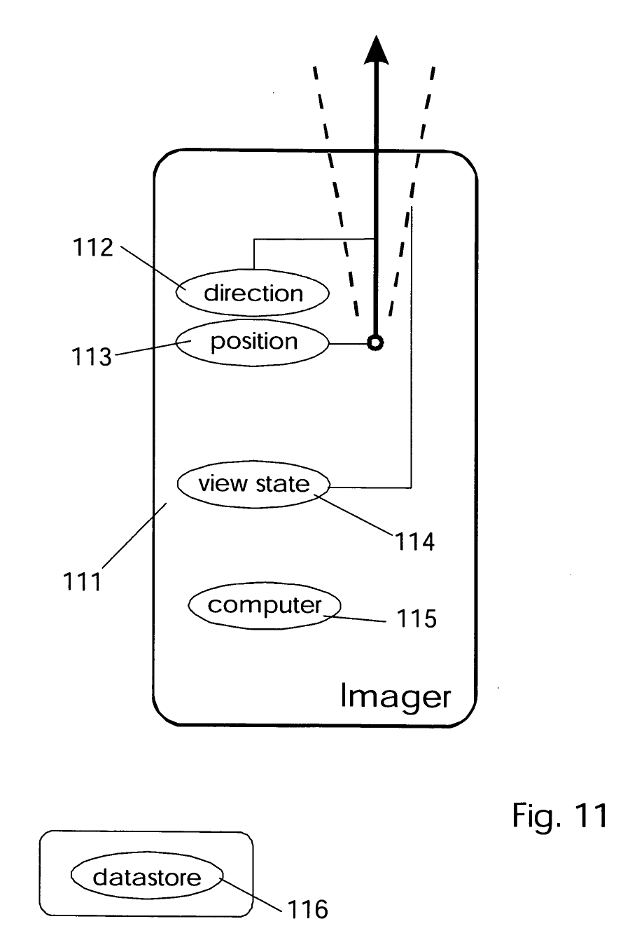

FIG. 12 is a method block diagram; and

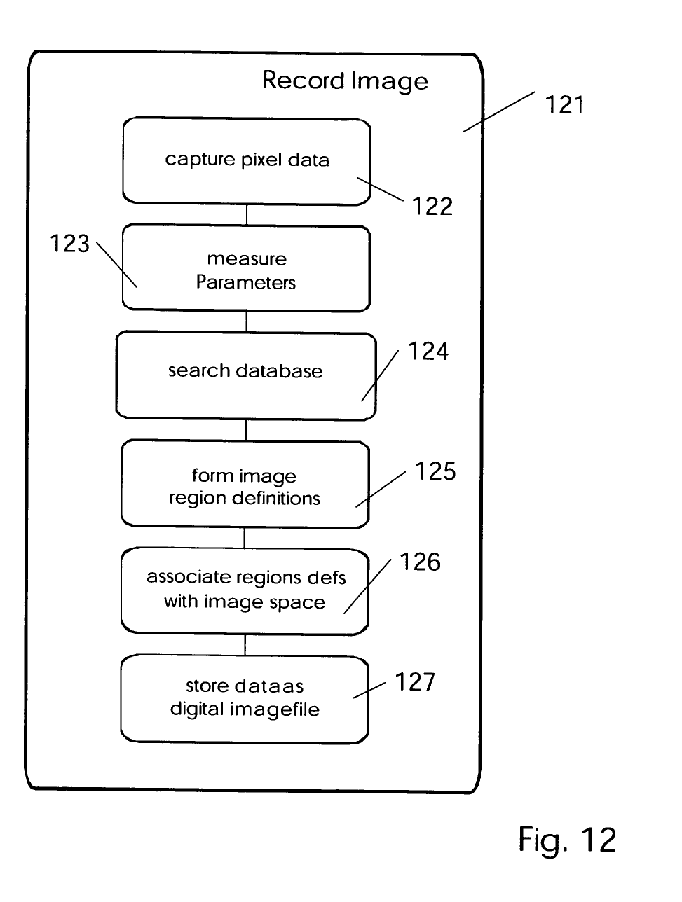

FIG. 13 is more detailed method block diagram.

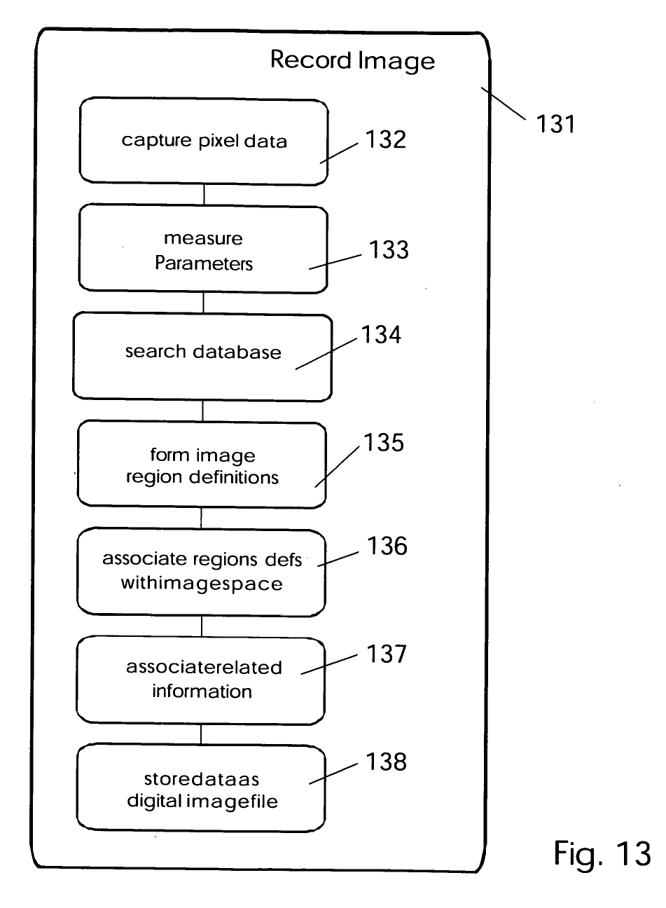

### GLOSSARY OF SPECIAL TERMS

Throughout this disclosure, reference is made to some terms which may or may not be exactly defined in popular dictionaries as they are defined here. To provide a more precise disclosure, the following terms are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must use the context of use and liberal discretion to arrive at an intended meaning. One will be well advised to error on the side of attaching broader meanings to terms used in order to fully appreciate the depth of the teaching and to understand all the intended variations. For purposes of this disclosure:

Pointing Imaging System—A ‘pointing imaging system’ is an imager or camera equipped with mean for measuring its pointing state or pointing attitude. In addition, sometimes these systems include position measurement and zoom state measurement sub-systems.

Geometric Descriptor—is the definition of a geometric body or geometric construct, for example a plane. Geometric descriptor as generally arranged to correspond to the space occupied by an object for example the space in which a building occupies.

Address Indicator—address indicator is a description of the pointing nature of a device. Usually an address indicator is a vector having its origin and direction specified. In some cases, an address indicator is a solid angle construct which corresponds to the field-of-view of an imager.

Solid Angle Field-of-Address—The field-of-view of an imager subtends a space having a point origin, rectangular cross section which increases proportionally with respect to the distance from the origin, and infinite extent.

View State—An imager ‘view-state’ is specified by physical parameters which define the particular viewing nature of the imager. These parameters include at least: it's position and it's pointing direction. In some cases, it also includes the zoom/magnification state, field-of-view, time, among others.

Image Map—An image map is a digital image file comprising pixel data and spatial definitions of sub-fields described as part of the image file.

Image Region—An Image Region is an image area or sub-field which is a subset or fractional portion of an entire image.

Internet Address—is a network address which specifies a network node's handle; in example a URL, or uniform resource locator, is a network address.

### PREFERRED EMBODIMENTS OF THESE INVENTIONS

In accordance with each of the preferred embodiments of these inventions, there is provided apparatus for and methods of forming image map hyperlinks integrated with image data. It will be appreciated that each of these embodiments described include both an apparatus and method and that the apparatus and method of one preferred embodiment may be different than the apparatus and method of another embodiment.

Pointing imaging systems produce special digital image files having advanced features. These imaging system not only capture image pixel data but additionally capture information relating to the scene which was previously stored in a database. Further, these systems capture information relating to the state of the imaging system at the time the image was made. Still further, the information is processed together to form special image files containing information which will support image map functionality with point-and-click hyperlinks when the images are played in suitable viewers/browsers.

Camera phones, or mobile telephones having imaging systems integrated therewith, are quite popular and now nearly ubiquitous. Full- service digital cameras are also quickly replacing those cameras known to many generations which form images on the chemical film medium. Both of these electronic devices provide a good platform upon which these inventions might be installed. These inventions require an imager of the digital electronic nature. Further, these inventions incorporate with such imagers additional subsystems such as position determining means, attitude determining means, view-state determining means, computer processors and database digital storage facility.

In short, image pixel data is captured. The computer determines which objects the scene is comprised. This is done by an implicit reasoning in view of prerecorded information. In an advanced database, the geometric properties of a great plurality of objects are stored. When it is determined that an object as defined by its geometric descriptor lies in the address field of the camera/imager, then it is said to be within the scene being addressed. Only objects known to the database are subject to recall. Objects which arrive in a scene after preparation of a database will be omitted. Similarly, objects taken from the scene (for example by fire) without a database update cause an error. However, when detailed and frequently updated databases are used, the objects which make up some image scenes will be well defined and known to these systems. Certainly, landmark buildings and the ir geometric definitions will be included in the most brief databases set up for these systems.

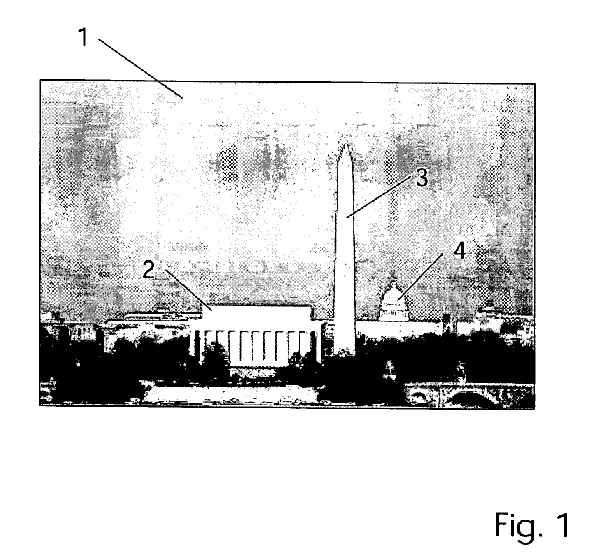

FIG. 1 is presented as it is comprised of a well known scene including at least three of the many important and recognizable landmarks of the U.S. capitol city Washington D.C. A tourist visitor to Washington D.C. is likely to make a photograph like the one shown. While the photograph shown is taken from exactly one predetermined viewpoint, it is highly unlikely that another photographer would find that precise viewpoint. As such, most every photograph which might be made will probably have perspective different than the perspective shown.

Systems taught herein account for images made from any viewpoint. When an image is made with a pointing imaging system, the imager determines viewpoint information by measure the position and pointing direction of the imager at the time an image is captured. In addition, information such as: lens magnification power; field-of-view; time-of-day; among others, may be determined and recorded. When in Washington D.C., a tourist having a pointing imaging system may form the image of FIG. 1. At the time of image capture, the imaging system measures the location of the imager, its pointing direction, and its field of view. These geometric parameters are used to recall information relating to objects in the imager's field-of-view.

A database prepared with recorded information is queried at the time of image pixel data capture. Thus, previously recorded information may be recalled in response to an image capture event. When the pointing nature of these imaging systems implies certain objects are being addressed, i.e. are at least partly within the imager's field-of-view, during an image capture event, information relating to those objects is recalled.

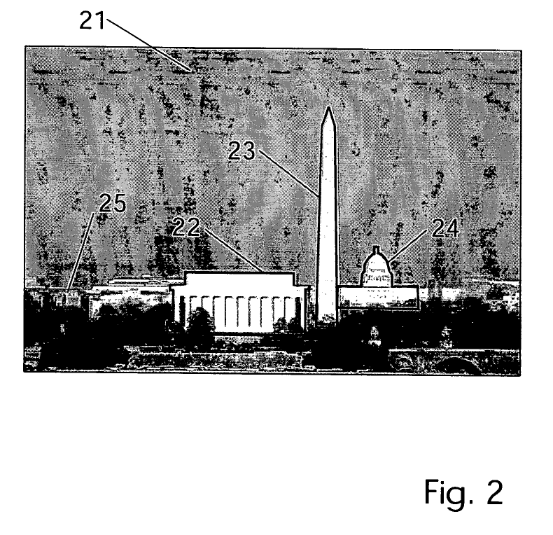

FIG. 2 illustrates the image 21 along with geometric descriptors which describe the space occupied by three important objects (buildings) in the image scene. Outlines 22, 23, and 24 represent geometric constructs know to the computer/database. While in the image they appear in two dimensions, the geometric descriptors of the database may be three dimensional models. Thus, from any point of view, a two dimensional outline can be formed to represent an object in the field of view of an imager.

When an image is captured, geometric descriptors are converted to area descriptions for each object for the in the proper perspective with respect to the point of view from which the image was made. Thereafter, associations are made between captured pixel data and area descriptions formed from the geometric descriptors.

An ‘image map’ is a relatively new computer object or device. Computer software experts have developed a particular human interface functionality well known as “point-and-click” actions. A pointer is aligned with a space on a computer monitor and a mouse click initiates a computer response. The response depends upon where the pointer is pointing. This is nicely illustrated by the ‘toolbar objects’ used in most computer applications. While most point-and-click actions involve icons; toolbars; or drop-down menus, for example, a special point-and-click action is devised for use with images. A normal image of simple pixel data may be converted to a special high performance image object with ‘hot spots’. Hot spots are particular regions within an image which can be made responsive to ‘mouse clicks’. Generally, an ‘image map object’ is embodied as a module of computer code, i.e. a set of computer instructions in combination with image pixel data. Hot spots are defined in the computer code modules. These are distinct from the image maps of these inventions.

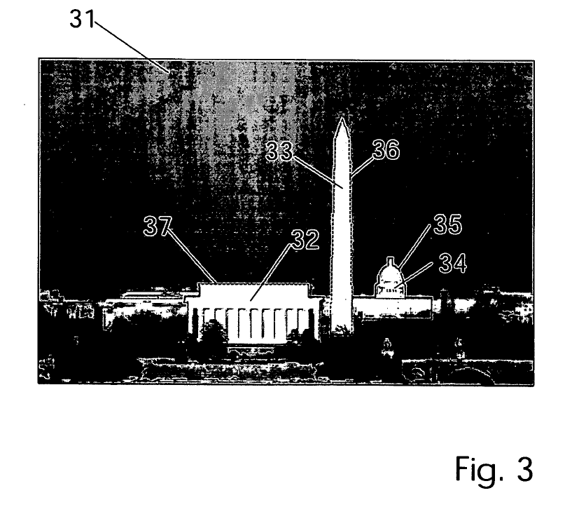

When an image is made in accordance with these inventions, sometimes an image map which includes the pixel data and image region definitions is formed. FIG. 3 illustrates an image map of the present invention. A landscape image 31 includes therein three buildings, the Lincoln Memorial 32, the Washington Monument 33, and the Capitol Building 34. The buildings are represented in the image by pixels which occupy certain image space. The image space associated with each of the three buildings is bounded by dotted lines 35, 36, and 37. When an image map of these inventions is stored, the pixel data is stored along with the image region definitions and an association between the two are is formed.

Image files of these inventions are not limited to the simple image map concepts of the art. Rather, these image files contain additional information elements. For example, in addition to the pixel data and image region definitions, compound image files first presented here may also contain Internet network address information (URLs). These URLs are not merely contained in a list of network addresses, but rather they are well connected with select spatial regions in the image. An image region defined in the image map may have associated therewith a URL. A URL which is appropriate for the any specific image map region is automatically assigned and associated with the region. For example, when an imager of these inventions is addressing a scene in Washington D.C., the scene including the Lincoln Memorial, the image may form an image file by first, capturing the image, second determining which objects are in the image via a database search based upon the position, attitude and zoom state of the imager, forming image region definitions, forming associations between the URLs with those particular image regions, and constructing a data file in accordance with a predetermined scheme, and storing the compound image file with image map and network address information.

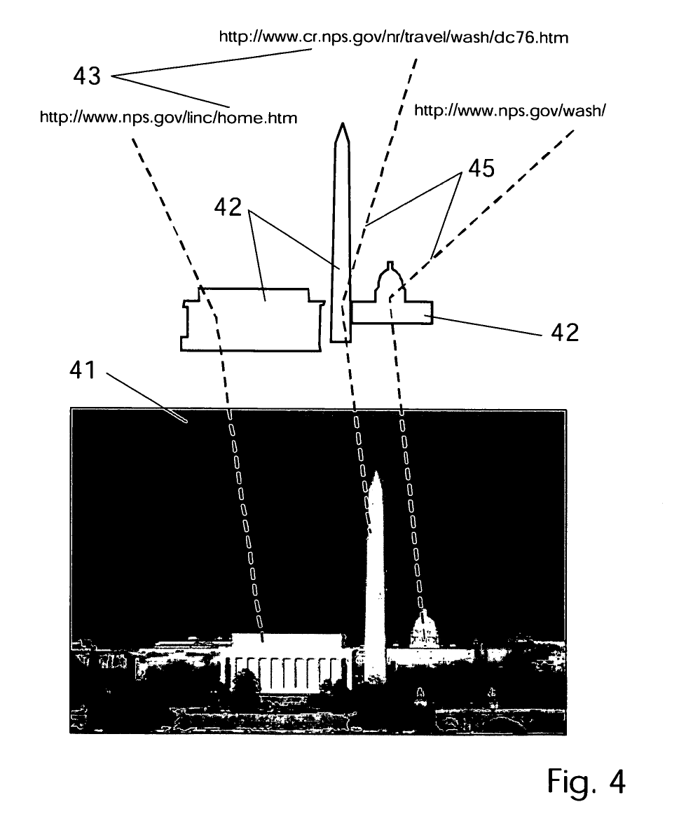

FIG. 4 illustrates. A captured image 41 is represented by pixel data. Two dimensional image regions 42 which correspond to objects known in a database are formed and associated with the proper portions of the pixel data. Certain web addresses 43, also part of information recalled in a database search, are associated with the proper portions of the image map. Dashed lines 45 are included to signify an association between a URL, an image region, and an area of the pixel image data. When the image is played back on an appropriate image viewer, a view aware of the file format, common image map functionality is enabled. The image is played as an image map object (for example a Java Applet, or a NET control) with functional hyperlinks.

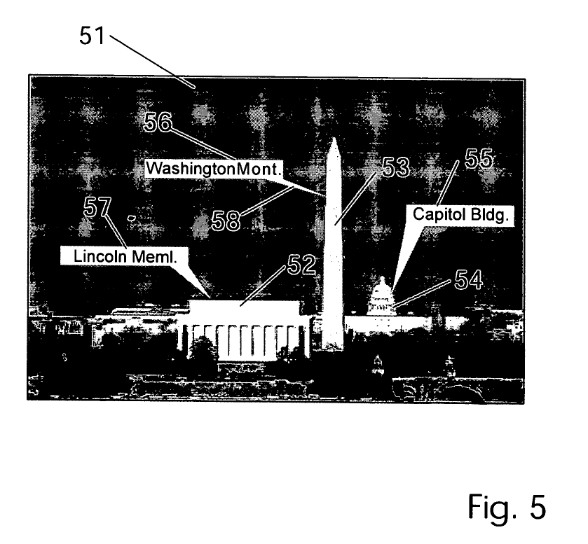

A special digital image file is thereafter prepared for storage. The image file not only contains pixel data, but in addition, also contains information associated with the image space, the imager properties, the state of the image capture event. In a first illustrative example, the Washington D.C. image is again considered. During image capture, it is determined by the computer that the image field includes the Lincoln Memorial, the Washington Monument, and the Capitol Building. Further, the geometric descriptors associated with these objects are converted to two dimensional image regions. These regions are properly aligned and associated with the image space in agreement with the image pixel data to form an image mapping system. Finally, simple label information is generated and connected with the image map system. These labels have text information which is particular to the object with which it is associated. FIG. 5 shows three object labels, each being associated or ‘connected’ to a particular image region by way of a pointer. The image 51 of Washington D.C. includes in the field-of-view the Lincoln Memorial 52, the Washington Monument 53 and the Capitol Building 54. At the time of image capture, a database search produced both image map regions and object labels. The image map regions are left invisible in the image presented as FIG. 5; however they continue to play an important role. They dictate where the tip of the label pointers must be located. Label 55, 56, and 57 each have a pointer which terminates in the region of the image occupied by the object associated with the label. Pointer 58 has a sharp tip which lies in the image space belonging to the Washington Monument. In this way, it is said that the labels are ‘associated’ with various image regions. Other associations may exist which do not rely on a single point lying within a predefined image area. It is important to note here that information (text labels) recalled from a database is combined with captured image pixel data to form a compound image. The information is combined with the pixel data and saved as a special high function image file. When the information is combined with the pixel data, associations are made between the recalled information and the image.

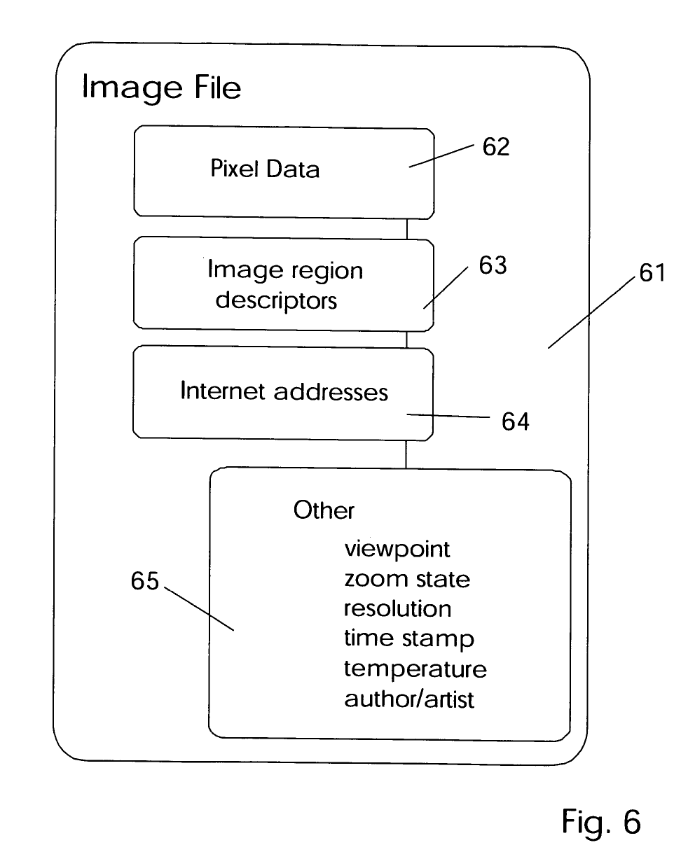

A better understanding is had in view of the block diagram of FIG. 6 which include further details regarding the image files which are constructed by imagers of these inventions. An image file of special format is created by pointing imaging systems. When a common digital camera is used to make a photograph, pixel data is captured and stored is a useful predefined data format. Sometimes, in advanced imagers, a timestamp is included with the image file. Further, special cameras have been devised to also include as part of the image file, data relating to the state of the imager such as f-stop, focal length, shutter speed, et cetera. These data can be used on image playback to control how the images are played back.

Similarly, image files created via devices and methods of these inventions contain pixel image data and imager state data. Further, they contain very special information relating to certain objects in the image scene. Namely, the objects which are determined to be in the scene as a result of considering the pointing state of the imager. An image map is formed automatically with image sub- field areas corresponding to the area occupied by objects as seen from the perspective of the imager. A careful observer will notice that for any viewpoint, the perspective and shape of image area for any object will be different for another viewpoint. Thus, the image map depends upon the viewpoint. A user does not have to determine the image area occupied by an object. Rather, a three dimensional geometric descriptor associated with the object and stored in the database is converted to a two dimensional area description which approximates the area occupied by an object from the viewpoint in which the image was made. This information element is certainly not found in any image file format.

An image file 61 is comprised of pixel data 62, image region descriptions 63, Internet addresses 64. In addition, these file formats may also include other data 65, such as viewpoint data, zoom state data, resolution data, time stamp data, temperature data, author/artist data, among others.

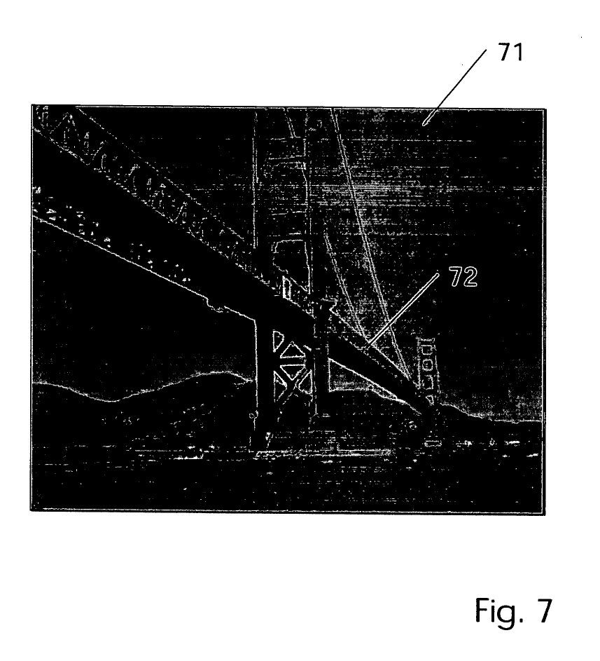

In review, we move to the United States west coast where one finds another famous landmark the Golden Gate Bridge 72. A certain viewpoint of the bridge necessarily implies a unique perspective thereof. A three dimensional model of the bridge stored in a computer memory can be adjusted to represent any perspective when viewed on a two dimensional medium. A photographer, located below and just East of the bridge on the San Francisco side of the bay would view the bridge as shown in the image 71 of FIG. 7.

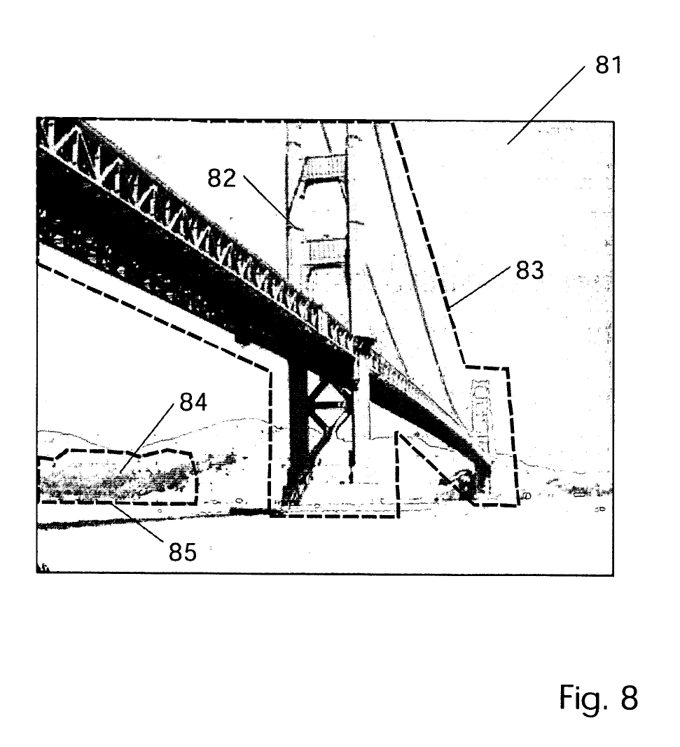

An imager equipped with position and attitude determining means, as well as zoom and view state determining means, captures pixel data. A database search which depends upon the imager position and attitude reveals that the Golden Gate Bridge is within (at least partly) the field-of-view. A geometric descriptor, a three dimensional model representing the space occupied by the bridge is recalled. A computation is made and applied to the model such that it is converted into a two dimensional area definition, an image region, which corresponds to a portion of the image space captured as pixel data. FIG. 8 is the same image 81 of the Golden Gate Bridge 82 which illustrates the image region area 83 which corresponds to the proper perspective of the bridge from the viewpoint in which the image was made. The image region area is computed from the three dimensional geometric descriptor recalled from a system database. In addition to the bridge, the computer also determines that a campground on the Marin side of the bridge is also in the field of view. The Brown's Bay Campsite 84 occupies space in the image designated by dashed outline and image region 85. When forming an image, the pixel data is recorded and the two dimensional image region data is also recorded. Further, an association is made between the pixel data and the image region definition. Still further, additional information is associated with various image regions. Web addresses recalled from the database are also associated with the image regions. Rectangular image space 91 contains at least two sub areas, image region 92 and image region 93. A URL associated with the Golden Gate Bridge, i.e. www.goldengatebridge.com 94 is connected and associated with the image region defined by the dashed line 92. Similarly, the URL www.campsite.com/ggb 95 is associated with the image region 93. These data and associations are stored together in a special digital image format. On playback in an appropriate player, the image is displayed normally. However, when a mouse cursor moves over the image space, hyperlinks are activated whereby a mouseclick on the campsite causes a browser to be directed to the corresponding web site. The image maps are formed at image capture time and require no input and design at the image post processing laboratory.

Because information is known about objects in an image scene via the database, it is possible that images are sorted and classified at the moment they are created. Image files therefore may include a classification tag. In example, images of landmarks may be labeled as such. Images of sunsets may be marked and identified accordingly. Images from a specific city, town center, country region, et cetera may all be properly catalogued automatically by way of marking the image file with class information recalled from the database. In this way, one records without effort, much more information about a favored scene. Such systems permit one to enjoy playback and sorting of images in a much more sophisticated way.

In our examples presented above, one might associate a ‘government buildings’ classification to the objects in Washington D.C. while attaching a ‘bridges and structures’ tag to the Golden Gate Bridge of San Francisco. A playback system could then sort the images accordingly either by structure type, or by city/state or by any of a large plurality of other sorting schemes.

Apparatus of these Inventions

Apparatus of these inventions can be better understood in view of the following. One will appreciate that new digital technology permits that small hand-held devices now easily accommodate sub-systems such as GPS and electronic compass. Thus, a digital camera or mobile phone with integrated camera imager can also support in combination therewith these advanced measurement systems which detail the physical state of the imager at any time.

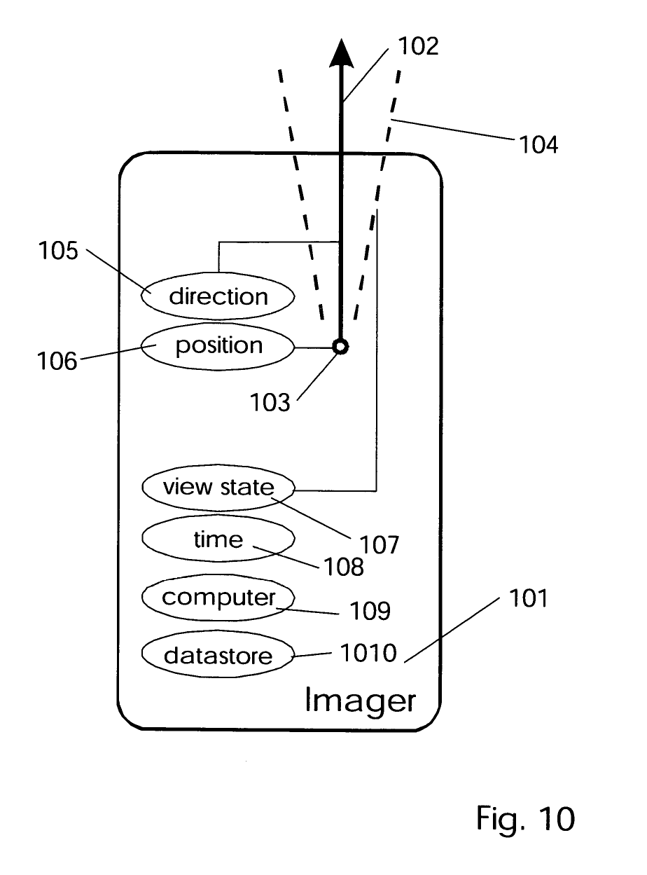

FIG. 10 is a diagram of a device of these inventions. An imager 101 has a reference direction 102, a point reference 103, and a field of view 104. Further, such imagers have means for determining position 106, pointing direction 105, and the view state 107 of the imager. Other ancillary devices such as a clock for providing time 108 functions may be included. A computer 109 runs application specific code and cooperates with data stored in a local database 1010. An alternative version 111 has direction, position and view state determining means, 112, 113, 114, respectively, and a computer 115. However, the computer may be in wireless communication with a remote database 116. In versions of imagers incorporated with mobile telephones, the computer can communicate with the database over high bandwidth 3G type mobile communications networks. In versions of high performance digital cameras without telephone functionality, the image may be provided with an 802.11 type wireless link, in example, to connect with the Internet or other data server.

Methods of these Inventions

In review, at image capture time pointing imagers of these inventions capture pixel data, determine position and attitude of the imager, recall geometric descriptors type three dimensional models of objects, converts those models to two dimensional image region definitions in proper perspective, and associates URLs, text labels, among others with these image regions to form a correspondence between image space and Internet space.

In most general terms, methods of the inventions may precisely be described as including the steps of: capturing a digital pixel image; determining imager view-state parameters; searching a database based upon view-state parameters; defining image region areas corresponding to objects recalled in database search; associating said image region areas with corresponding image space in said pixel image; and forming a compound data file comprising pixel image information and associated information relating to the scene.

Searching a database further includes recalling information which is related to objects within the field-of-view of the imager. This is done by finding geometric intersection between a geometric descriptor of a stored record and the solid angle field-of-address of the imager at the time pixel data is captured. Where stored records also include network addresses, those may also be recalled from memory and associated with appropriate image regions. Similarly, text labels may also be recalled and associated with image regions.

Image scenes may be classified via classification identifiers which also are recalled from memory in database search operations. Information element relating to the imager state includes those of the group: present time, f-stop, shutter speed, and artist/author, may also be attached to a image map data file of these systems.

One will now fully appreciate how pointing images create advanced images having associated therewith important related information elements. Further, how image map systems including hyperlink functionality is automated. Although the present inventions have been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

We claim:

1) Methods of recording information relating to a scene comprising the steps:
capturing a digital pixel image;
determining imager view-state parameters;
searching a database based upon view-state parameters;
defining image region areas corresponding to objects recalled in database search;
associating said image region areas with corresponding image space in said pixel image; and
forming a compound data file comprising pixel image information and associated information relating to the scene.

2) Methods of recording information relating to a scene of claim 1, said ‘searching a database’ step is further defined as recalling information related to objects within the field-of-view of the imager.

3) Methods of recording information relating to a scene of claim 2, said ‘searching a database step’ includes finding geometric intersection between the geometric descriptor of a stored record and the solid angle field-of-address of the imager at the time pixel data is captured.

4) Methods of recording information relating to a scene of claim 3, said ‘searching a database step’ further includes recalling from memory a 3D model or geometric descriptor where intersection is determined in said database search.

5) Methods of recording information relating to a scene of claim 4, said ‘searching a 30 database step’ further includes recalling from memory a network address.

6) Methods of recording information relating to a scene of claim 5, said ‘searching a database step’ further includes recalling from memory an Internet uniform resource locator.

7) Methods of recording information relating to a scene of claim 4, said ‘searching a database step’ further includes recalling from memory text labels.

8) Methods of recording information relating to a scene of claim 4, said ‘searching a database step’ further includes recalling from memory a classification identifier.

9) Methods of recording information relating to a scene of claim 1, said ‘determining imager view state parameters’ includes determining imager position and pointing attitude.

10) Methods of recording information relating to a scene of claim 9, said view-state parameters further include: magnification and field-of-view.

11) Methods of recording information relating to a scene of claim 9, further includes any of imager related information from the group including: present time, f-stop, shutter speed, and artist/author.

12) Methods of recording information relating to a scene of claim 1, said ‘defining image region areas’ further includes converting three dimensional geometric descriptor models to two dimensional image region areas in agreement with the perspective of the scene as viewed from the imager.

13) Methods of recording information relating to a scene of claim 12, said ‘associating said image region areas’ step further includes aligning two dimensional image region areas with corresponding space in the digital pixel image captured.

14) Methods of recording information relating to a scene of claim 13, said ‘associating said image region areas’ step further includes associating network addresses with regions to form a one-to-one correspondence whereby an image map with hot spot hyperlinks is formed;

15) Methods of recording information relating to a scene of claim 5, associating said network address with an image region area forming a one-to-one correspondence between objects and network addresses.

16) Methods of recording information relating to a scene of claim 7, associating said label with an image region area forming a one-to-one correspondence between objects and labels.

17) Imaging systems comprising:
a digital imager;
position and attitude determining means;
a computer processor; and
a database,
said position and attitude determining means having outputs coupled to said computer processor such that stored information is recalled from said database in agreement with position and attitude values and associations are formed between image regions and information recalled.

18) Imaging systems of claim 17, further comprises view state determining means which further defines the geometric nature of the solid angle field of address.

19) Imaging systems of claim 18, further comprising physical systems including a clock; thermometer; and text input means.
